(19) United States
(12) Patent Application Publication
(10) Pub. No.: US 2011/0267702 A1
(43) Pub. Date: Nov. 3, 2011

(54) HEAD UP DISPLAY SYSTEM

(75) Inventors: Naotoshi Fujimoto, Wako-shi (JP); Kotaro Takashima, Wako-shi (JP)

(73) Assignee: HONDA MOTOR CO., LTD., Tokyo (JP)

(21) Appl. No.: 13/095,102

(22) Filed: Apr. 27, 2011

(30) Foreign Application Priority Data
Apr. 28, 2010 (JP) 2010-103242
Jun. 16, 2010 (JP) 2010-137357

(51) Int. Cl. G02B 27/01

(52) U.S. Cl. 359/633; 359/630

(57) ABSTRACT

The head up display system (1) comprises a housing (5) installed within a dashboard panel (3) of the vehicle and provided with an open end (5o), a light emitting display device (12) placed in an opposite end of the housing remote from the open end to emit a display light, an optical unit (13; 23; 33; 43; 53; 63; 73) interposed between the light emitting display device and the open end of the housing. An outer element of the optical unit which may consist of a prism (15; 25; 35; 75) or a beam splitter (45) is configured to reflect an incident external light entering from the windshield (2) at least partly at an angle to the display light emitted from the outer element of the optical unit. Thereby, the external light reflected by the outer element of the optical unit may be directed into the housing or otherwise directed away from the vehicle operator's field of view, and the vehicle operator is allowed to obtain information simply by looking ahead of the vehicle without being annoyed by the external light.

### TECHNICAL FIELD

The present invention relates to a head up display system for vehicles that presents an image to be seen through a windshield by a vehicle occupant by projecting the display image onto the windshield from a display device placed inside the vehicle.

### BACKGROUND OF THE INVENTION

The head up display system is known as a means for displaying information in the driver's field of view by using the windshield as a screen for a display device installed in the dashboard panel. See patent JP60-169346A (patent document 1) for instance. JP2007-86226A (patent document 2) discloses a head up display device for a vehicle provided with a mirror that is angularly moved so that the projected image is allowed to move vertically in the driver's field of view.

In such a system, the display device is placed in a recessed part of the dashboard panel, and is thereby concealed from the view of the vehicle operator. The surface of the windshield on which the display light is projected typically consists of a one-way mirror which may be attached to the inner side of the windshield or may be formed by the windshield itself by applying a transparent coating thereon.

FIG. 15 shows a conventional head up display system in which a head up display device 80 is placed in a bottom part of a cylindrical housing 5. The housing 5 is installed in a dashboard panel 3, and is provided with an open top 5a which opens out at an opening formed in the upper wall of the dashboard panel 3. An image or light emitted from a light emitting display device 82 provided in the bottom part of the housing 5 is converted into a parallel light beam by a convex lens 85, and the parallel light beam is reflected by the inner surface of the windshield 2 at such an angle that the displayed image is seen by the vehicle driver as if the image were located at some distance ahead of the windshield 2.

In such a head display system, external light 7a entering the passenger compartment 4 via the windshield 2 may be reflected by the outer surface of the convex lens 85, and this reflected light 7b may be reflected by the windshield 2 and come into the vehicle driver's view. This may cause glare to the vehicle operator or otherwise prevent the vehicle operator paying attention to the road ahead of the vehicle.

To mitigate this problem, it has been practiced to place the light emitting display device 82 deep into the housing 5, and provide a protective sheet 88 in front of the convex lens 85 to reduce the reflection of the external light by the outer surface of the convex lens 85. The protective sheet 88 partially reflects and/or absorbs the incident light, and reduces the amount of the light reflected by the convex lens 85 and directed to the vehicle occupant's field of view.

However, the protective sheet 88 also reduces the intensity of the display light, and is therefore only a partial solution to this problem.

### BRIEF SUMMARY OF THE INVENTION

In view of such problems of the prior art, a primary object of the present invention is to provide a head up display system that can prevent external light reflected by an outer element of an optical unit of the head up display system from reaching the vehicle operator's view without substantially diminishing the intensity of the display light.

A second object of the present invention is to provide a head up display system that can prevent external light reflected by an outer element of an optical unit of the head up display system from reaching the vehicle operator's view, and is provided a highly compact structure.

According to the present invention, such objects can be accomplished by providing a head up display system for a vehicle including a windshield and a dashboard panel located opposite to an inner surface of the windshield, comprising: a housing installed within a dashboard panel of the vehicle, and having an open end opening out in an upper wall of the dashboard panel; a light emitting display device placed in an opposite end of the housing remote from the open end to emit a display light; and an optical unit interposed between the light emitting display device and the open end of the housing; wherein an outer element of the optical unit is configured to reflect an incident external light entering from the windshield at least partly at an angle to the display light emitted from the outer element of the optical unit.

Thereby, the external light reflected by the outer element of the optical unit may be directed into the housing or otherwise directed away from the vehicle operator's field of view, and the vehicle operator is allowed to obtain information simply by looking ahead of the vehicle without being annoyed by the external light. Typically, the external light is directed to the rear wall of the housing, and the worst case is caused by the external light entering from an upper edge of the windshield impinging upon a certain point of the outer element of the optical unit. By configuring the optical unit such that the external light entering from an upper edge of the windshield is directed away from the vehicle operator's field of view, the vehicle operator is protected from the glare of the external light at all times.

According to a preferred embodiment of the present invention, the display light emitted from the light emitting display device is refracted by a prism included in the optical unit into a direction different from the direction of the external light reflected by the outer element of the optical unit. Typically, a convex lens is interposed between the light emitting display device and the prism for the purpose of converging the display light radiated from the light emitting display device.

To allow the head up display system to be incorporated in a limited space of the dashboard panel, at least one of the prism and convex lens may be formed as a Fresnel lens. If desired, the prism and convex lens may be incorporated in a single composite Fresnel lens. The optical unit may further comprise a light absorbing member that attenuate light transmitted through the optical unit.

According to another embodiment of the present invention, the outer element of the optical unit comprises a beam splitter.

According to a certain aspect of the present invention, the light emitting display device is placed in a rear end part of the housing, and the optical unit comprises a mirror provided in a front end part of the housing such that a display light emitted from the light emitting display device is reflected by the mirror, and projected onto an inner surface of the windshield via the opening in the dashboard panel. The mirror may be incorporated with a prism layer. Alternatively, the mirror may be provided with a plurality of laterally elongated reflection surface segments arranged in a vertical direction and each slanted in an upward direction.

### BRIEF DESCRIPTION OF THE DRAWINGS

Now the present invention is described in the following with reference to the appended drawings, in which:

FIG. 1 is a simplified sectional side view of a first embodiment of the head up display system according to the present invention;

FIG. 2 is an enlarge sectional side view of the head up display device used in the head up display system of FIG. 1;

FIG. 3 is a diagram showing the path of external light directed to the head up display device shown in FIG. 1;

FIGS. 4a to 4c show the path of the incident light and reflected light in each of three possible situations with respect to the head up display system shown in FIG. 1;

FIG. 5 is a view showing the first embodiment superimposed on the prior art illustrated in FIG. 15 for comparison;

FIG. 6 is a view similar to FIG. 2 showing a modification of the first embodiment;

FIG. 7 is a view similar to FIG. 2 showing another modification of the first embodiment;

FIG. 8 is a view similar to FIG. 1 showing a second embodiment of the present invention;

FIG. 9 is an enlarge sectional side view of the head up display device used in the head up display system of FIG. 8;

FIG. 10 is a view similar to FIG. 1 showing a third embodiment of the present invention;

FIG. 11 is an enlarge sectional side view of the head up display device used in the head up display system of FIG. 10;

FIG. 12 is a diagram showing the path of external light directed to the head up display device shown in FIG. 10;

FIG. 13 is a view similar to FIG. 11 showing a modification of the third embodiment;

FIG. 14 is a view similar to FIG. 11 showing another modification of the third embodiment; and

FIG. 15 is a simplified sectional side view of a conventional head up display system.

### DETAILED DESCRIPTION OF THE PREFERRED EMBODIMENTS

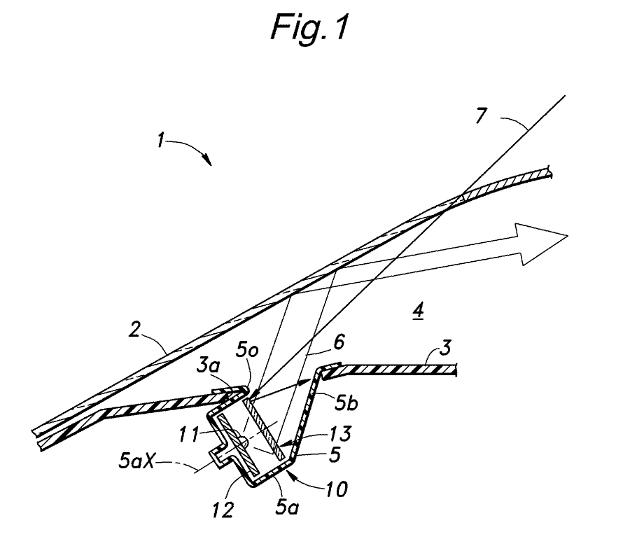

FIGS. 1 to 5 show a head up display system 1 embodying the present invention. Referring to FIG. 1, a dashboard panel 3 is provided under a front windshield 2 of a motor vehicle 1, and the inner surface of the windshield 2 and upper surface of the dashboard panel 3 define a part of a passenger compartment 4. An opening 3a is formed in a front part of the dashboard panel 3 typically in front of a vehicle operator's seat, and is fitted with a housing 5 defining a recess in the dashboard panel 3. In other words, the housing 5 has a closed bottom and an open top 5o opening out toward the passenger compartment 4 at the dashboard panel 3.

The housing 5 includes a cylindrical bottom part 5a having a central axial line 5ax that tilts rearward with respect a vertical line and a connecting wall 5b that smoothly connects the upper end of the bottom part 5a with the dashboard panel 3. In other words, the central axial line 5ax extends at an angle to the approximately horizontal upper surface of the dashboard panel 3. The front edge of the cylindrical bottom part 5a directly abuts the dashboard panel 3 at the front end of the opening 3a, and the connecting wall 5b is provided with a larger vertical extent in a rear part thereof. A head up display device 10 is received in the bottom part of the cylindrical bottom part 5a.

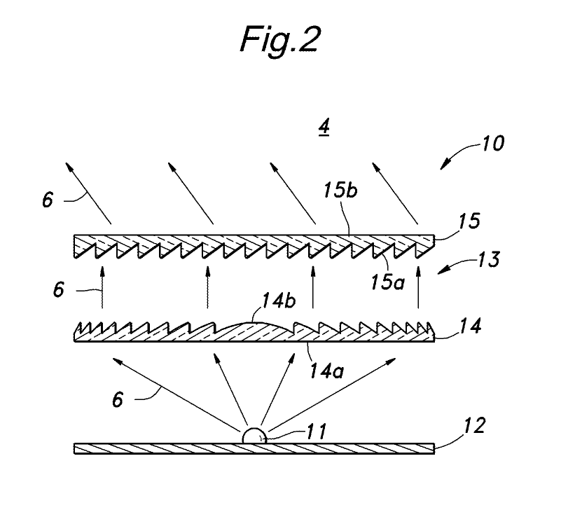

The head up display device 10 is configured to emit a display light 6 onto the windshield 2 to form an image for the vehicle operator to see. The image may be a warning for a rear end crash, but may also consist of any other image for providing information to the vehicle operator. As shown in FIG. 2 also, the head up display device 10 comprises a planar light emitting display device 12 including a LED 11 mounted on a circuit board extending perpendicularly to the central axial line 5ax of the housing 5 at the bottom of the cylindrical bottom part 5a and an optical unit 13 provided in an upper part of the cylindrical bottom part 5a and configured to project the display light 6 emitted from the LED 11 onto the windshield 2 so as to form an image which the vehicle operator perceives as being located as some distance ahead of the vehicle.

The light emitting display device 12 in this embodiment, as well as those of the following embodiments, employs a LED 11 as a display light source, but may also consist of an LCD, VFD or other two-dimensional display devices so that more diverse information may be displayed on the windshield. Also, the application of the head up display system is not limited to the rear end crash warning system, but may also be used in any system that provides information to the vehicle operator or other vehicle occupants.

The optical unit 13 comprises a convex lens 14 that refracts the light radiating from the LED 11 inward toward the central axial line 5ax into a parallel light beam perpendicular to the major surface of the light emitting display device 12 and a prism lens 15 disposed on the passenger compartment side of the convex lens 14 and refracts the parallel light beam upward or toward the windshield 2. The convex lens 14 is provided with a flat surface 14a facing the light emitting display device 12 and a convex surface 14b facing the passenger compartment 4, and formed as a Fresnel lens having a reduced thickness by dividing the entire lens into a number of concentric rings and arranging then in a planar fashion. In the illustrated embodiment, the central axial line 5ax of the housing 5 coincides with the optical center line of the optical unit 13. The convex lens 14 may also consist of a simple convex lens or a combination of a plurality of lenses without departing from the spirit of the present invention.

The prism lens 15 is provided with a flat surface 15b facing the passenger compartment 4 and extending perpendicularly to the central axial line 5ax, and a terraced prism surface 15a facing the convex lens 14. The prism lens 15 is formed by a plurality of prism segments elongated in the lateral direction, and arranged in the fore and aft (vertical) direction in a planar fashion. The side of the prism lens 15 facing the convex lens 14 is defined by a plurality of prism surface segments each consisting of a vertical front side and an oblique rear side as seen in sectional side view. The prism segments are configured such that the incident light from the convex lens 14 is refracted upward with respect to the central axial line 5ax. The prism surface is coated with a low reflectance layer or otherwise processed so as to demonstrate a low reflectance. The prism lens 15 may also consist of a simple prism that typically has a triangular cross section or any other prism that refracts the incident light upward without departing from the spirit of the present invention. The surface of the connecting wall 5b may be also coated with a low reflectance layer or otherwise processed so as to demonstrate a low reflectance.

Thus, the head up display device 10 projects the display light 6 radiating from the LED 11 onto the front windshield 2 as a parallel light beam directed or angled upward with respect to the central axial line 5ax of the light emitting display device 12. The light beam forms an imaginary image ahead of the vehicle that can be viewed by the vehicle operator through the windshield 2.

The head up display device 10 is oriented at such an angle that external light 7 such as sunlight entering the passenger compartment 4 through the windshield 2 and reflected by the outer flat surface of the prism lens 15 is contained within the housing 5 as will be described hereinafter.

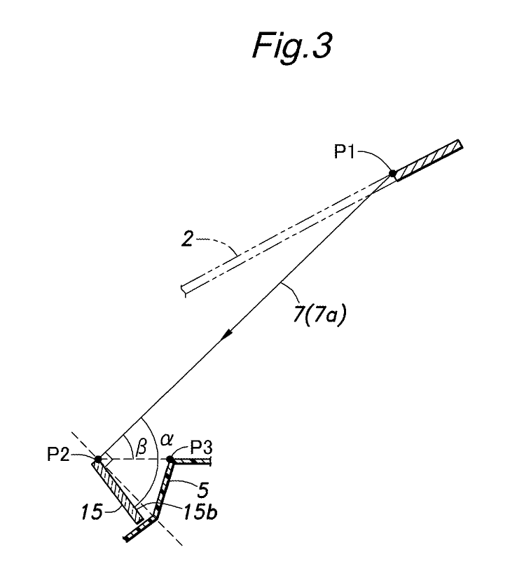

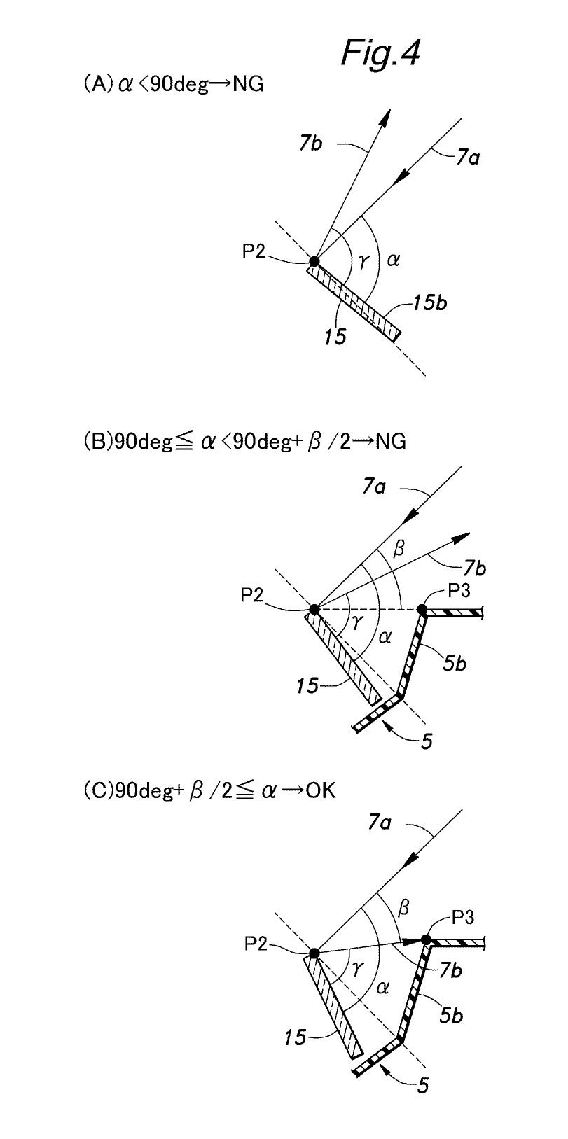

The optical property of the prism lens 15 is described in the following with reference to FIGS. 3 and 4. First of all, suppose that the external light 7 passes an upper edge point P1 of the windshield 2, and impinges upon the upper edge point P2 of the prism lens 15. This is the worst case in terms of the annoyance of the external light to the view of the vehicle operator. The angle between the incident light 7a and the outer surface of the prism lens 15 is named as α, and the angle between the incident light 7a and the line connecting point P2 and the rear edge point of the opening 3a of the dashboard panel 3 is named as β.

If the angle α is smaller than 90 degrees, the incident light 7a impinging upon point P2 is reflected by the outer surface of the prism lens 15 in the forward direction as shown in FIG. 4a. When the angle between the incident light 7a and the outer surface of the prism lens 15 is named as γ, γ is greater than α(γ>α). Therefore, the reflected light 7b impinges upon the front windshield 2, and this light may come into the field of view of the vehicle operator.

If the angle α is greater than 90 degrees but smaller than (90+β/2) degrees, the incident light 7a impinging upon point P2 is reflected by the outer surface of the prism lens 15 in the rearward direction and is not obstructed by the rear edge of the opening 3a (point P3) as shown in FIG. 4b or γ is smaller than α(γ<α). Therefore, the reflected light 7b does not impinge upon the windshield 2, but is directed into the passenger compartment 4, and may cause a glare to the vehicle operator.

If the angle α is greater than (90+β/2) degrees (α>90+β/2), the reflected light 7b impinges upon the inner wall of the housing 5 or the connecting wall 5b of the housing 5, and is directed neither to the windshield 2 or into the passenger compartment 4 as shown in FIG. 4c. Therefore, the external light 7b reflected by the outer surface of the prism lens 15 does not come into the field of view of the vehicle operator.

By placing the housing 5 with respect to the windshield 2 such that α is greater than (90+β/2) degrees, even when the external light 7 is passed from the uppermost point of the windshield or point P1 to the uppermost or front most point of the prism lens 15 or point P2, the external light 7 reflected by the prism lens 15 impinges upon the connecting wall 5b of the housing 5 without being directed to the vehicle operator or to the windshield 2. The external light entering the passenger compartment 4 from any other part of the windshield 2 or the external light directed to any other part of the outer surface 15b of the prism lens 15 is reflected by the outer surface 15b of the prism lens 15 onto the inner wall of the housing 5, and is less likely to annoy the vehicle operator. Therefore, the vehicle operator is not annoyed by glare caused by the external light 7 reflected by the prism lens 15.

When the head up display device 10 of the illustrated embodiment is used as a warning device in a rear end crashing warning system, the vehicle operator can be properly warned without being required to watch the instrument panel as the warning light comes from the front via the windshield. Therefore, the vehicle operator is allowed to pay full attention to the front of the vehicle at all times.

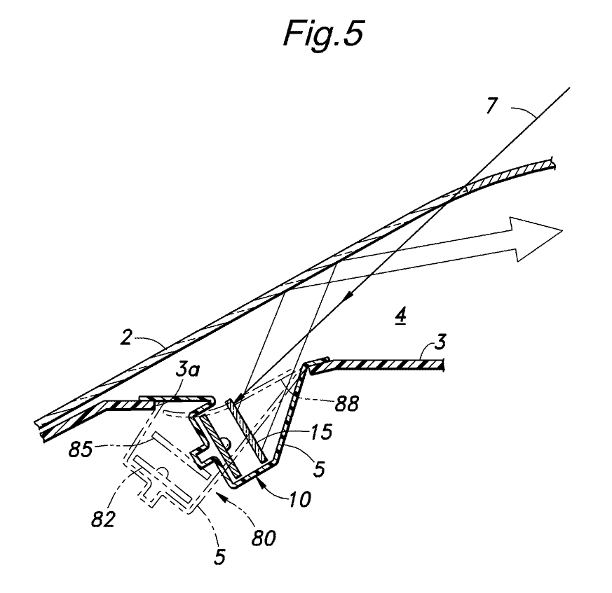

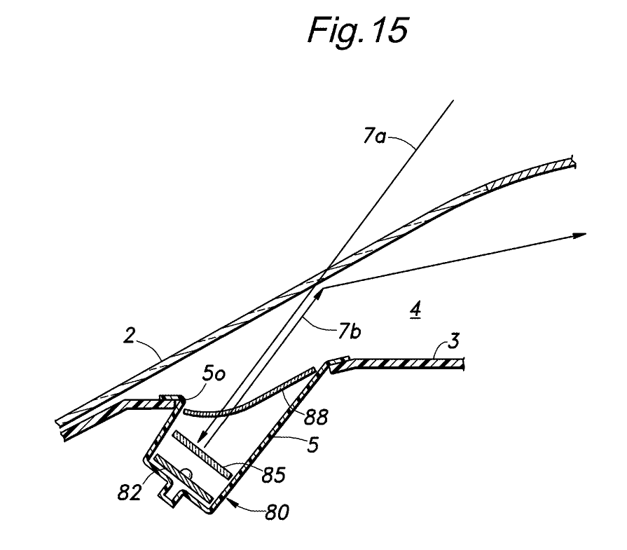

As can be appreciated from the foregoing description and FIG. 5 which compares the first embodiment with the prior art illustrated in FIG. 15, the present invention eliminates the need for providing the protective sheet 88 in the opening of the housing or increasing the depth of the housing 5 to prevent the vehicle occupant from glare or other optical disturbances as in the conventional head up display system. Therefore, the head up display system can be designed in a highly compact and economical manner, and the heat protection measures for the head up display device can be simplified. By applying a low reflectance process to the outer surface 15b of the prism lens 15, the reflection from the prism lens 15 can be minimized, and the intensity of the light directed to the inner surface of the housing 5 or the connecting wall 5b thereof can be minimized. Thereby, the optical disturbances to the vehicle operator is minimized. If desired, the inner surface of the housing 5 or the connecting wall 5b may also be processed so as to have a reduced reflectance.

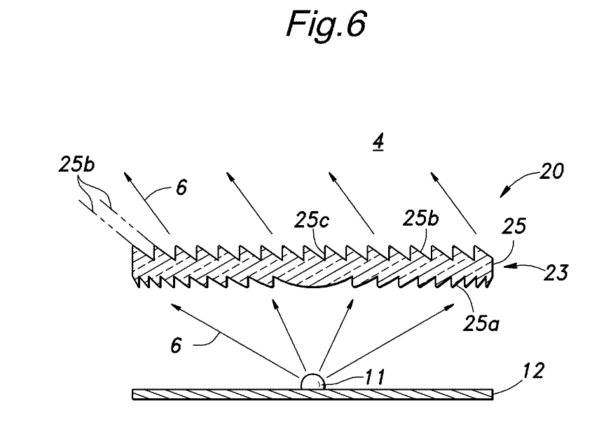

A modification of the first embodiment is described in the following with reference to FIG. 6. In the following description, the parts corresponding to those of the first embodiment are denoted with like numerals without repeating the description of such parts.

Referring to FIG. 6, the head up display device 20 of the modified embodiment comprises an optical unit 23 using a single composite lens 25. This composite lens 25 combines a convex lens and a prism lens in a single lens. The side of the composite lens 25 facing the light emitting display device 12 is formed as a combination of annular convex surface segments that jointly form a Fresnel convex lens, and refract the light radiating from the LED 11 into a parallel light beam extending along the central axial line 5ax. The side of the composite lens 25 facing the passenger compartment 4 is formed as a prism surface consisting of a plurality of prism segments arranged in a planar fashion so that the parallel light beam formed by the Fresnel convex lens is refracted in an upward direction as in the first embodiment. Each prism segment extends in the lateral direction, and defines a vertical front side and an oblique rear side as seen in sectional side view.

As this embodiment uses only one lens, the number of component parts can be reduced, the manufacturing cost can be reduced, and a more compact design can be achieved.

According to this embodiment, because the vertical surface of each prism segment is directed toward the windshield 2, the light entering the passenger compartment 4 from the windshield 2 is reflected more backward than in the first embodiment so that the light reflected by the outer surface of the prism lens is all the more confined within the housing 5. Therefore, even when the angle α is smaller than (90+β/2) degrees or even when the angle α is smaller than 90 degrees, the light reflected by the outer surface of the composite lens may be confined within the housing 5.

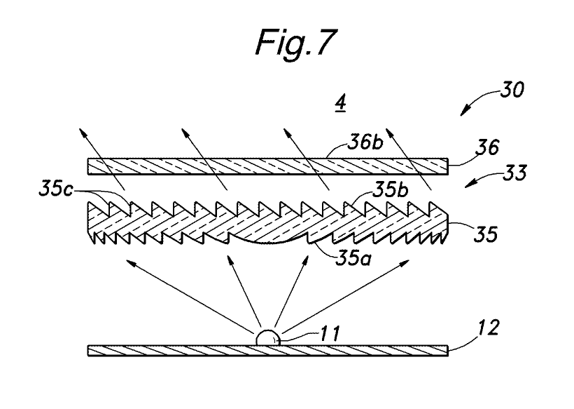

Another modification of the first embodiment is described in the following with reference to FIG. 7. In the following description, the parts corresponding to those of the first embodiment are denoted with like numerals without repeating the description of such parts.

This modified embodiment is similar to the previous modified embodiment, but is additionally provided with a protective sheet 36 having two sides that are parallel to each other, and placed on the passenger compartment side of the composite lens 15. The outer surface 36b of the protective sheet 36 may be angularly positioned so as to meet the condition that α>90+β/2. Thereby, the external light reflected by the outer surface 36b of the protective sheet 36 is directed to the inner wall of the housing 5 or the connecting wall 5a thereof. The protective sheet 36 additionally prevents the intrusion of foreign matters into the housing 5 or into the optical unit 33, and protects the outer surface of the composite lens 15 from contamination.

The outer surface 36b of the protective sheet 36 facing the passenger compartment 4 may be provided with a low reflectance surface so that the reflection of the external light by the outer surface 36b of the protective sheet 36 may be minimized. Also, if the protective sheet 36 is provided with a property to absorb a part of the light transmitted therethrough, the light reflected by the outer surface of the composite lens 35 can be controlled as the external light has to pass through the protective sheet 36 before reaching the field of view of the vehicle operator while the display light passes the protective sheet 36 just once before reaching the field of view of the vehicle operator.

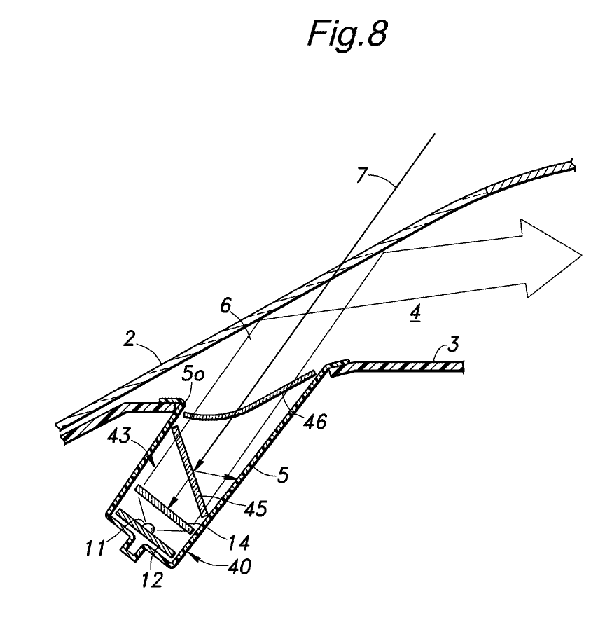

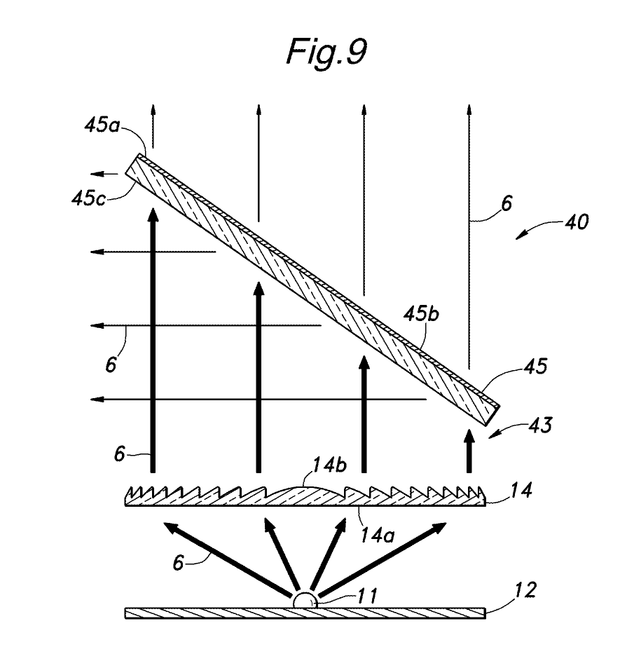

A second embodiment of the present invention is described in the following with reference to FIGS. 8 and 9. In the following description, the parts corresponding to those of the first embodiment are denoted with like numerals without repeating the description of such parts.

Referring to FIG. 8, the housing 5 of this embodiment is cylindrical in shape, and is more elongated than that of the first embodiment. The housing 5 is slanted rearward with respect to a vertical line, and has an upper opening 5o merging obliquely with the dashboard panel 3 and opening out at an opening of the dashboard panel 3. A head up display device 40 is provided in a bottom part thereof. The head up display device 40 comprises a planar light emitting display device 12 including a LED 11 mounted on a circuit board extending perpendicularly to the central axial line 5ax of the housing 5 at the bottom thereof and an optical unit 43 provided in an upper part of the cylindrical housing 5 and configured to project the light 6 emitted from the LED 11 onto the windshield 2 so as to form an image which the vehicle operator perceives as being located as some distance ahead of the vehicle.

As shown in FIG. 9 also, the optical unit 43 comprises a convex lens 14 that refracts the light radiating from the LED 11 inward toward the central axial line 5ax into a parallel light beam perpendicular to the major surface of the light emitting display device 12 and a beam splitter (one-way mirror) 45 located on the passenger compartment side of the convex lens 14. A transparent protective sheet 46 is provided on the opening 5o of the housing 5. The protective sheet 46 is angled and curved so as to minimize the disturbances from the external light 7. The beam splitter 45 is formed by depositing a reflective film 45b (such as aluminum, silver, tin, etc.) on a side (passenger compartment side in this embodiment) of a transparent plate 45c facing the passenger compartment 4, and has the property to transmit a part of incident light and reflect the remaining part of the incident light. In the illustrated embodiment, the beam splitter 45 is configured to reflect 50% of the incident light, and transmit the remaining 50% of the incident light. The beam splitter 45 is tilted rearward by about 45 degrees from a plane perpendicular to the central axial line 5ax. Therefore, the parallel light beam exiting the convex lens 14 is partly transmitted through the beam splitter 45 and impinges upon the windshield 2 while the remaining part of the parallel light beam exiting the convex lens 14 is reflected onto the front wall of the housing 5.

The angular orientation of the beam splitter 45 is determined such that the outer surface 45a of the beam splitter 45 reflects a part of the external light 7 entering the passenger compartment 4 via the front windshield 2 onto a rear wall of the housing 5, and the remaining part of the external light 7 transmits the beam splitter 45 and is directed onto the convex lens 14. A most part of the external light 7 projected onto the convex lens 14 passes through the convex lens 14 and projected onto the light emitting display device 12 to be absorbed by the light emitting display device 12. Only a small fraction of the external light 7 projected onto the convex lens 14 is reflected by the convex surface thereof. Furthermore, about a half of this small fraction of the external light (or the reflected light) is reflected by the beam splitter 45 and projected onto the front wall of the housing 5, and only the remaining half of the diffused and attenuated reflected light is allowed to exit from the optical unit 43 so that the external light 7 reflected by the head up display device 40 is highly attenuated before reaching the eyes of the vehicle operator, and the vehicle operator is thereby prevented from the annoyance of the external light.

The beam splitter 45 was used in the optical unit in the foregoing embodiment, but may also use a tinted film or frosted sheet that transmits a part of the incident light and absorbs the remaining part of the incident light for the same purpose. When a tinted film is used, the incident light that is not reflected by the outer surface of the beam splitter 45 is attenuated by the tinted film before passing through the convex lens 14, and the external light reflected by the convex lens 14 or the display device 12 passes through the tinted film once again before exiting the optical unit and being projected onto the windshield. On the other hand, the display light radiating from the display device 12 and transmitted through the convex lens 14 passes through the tinted film only once so that the attenuation of the display light by the tinted film is relatively small.

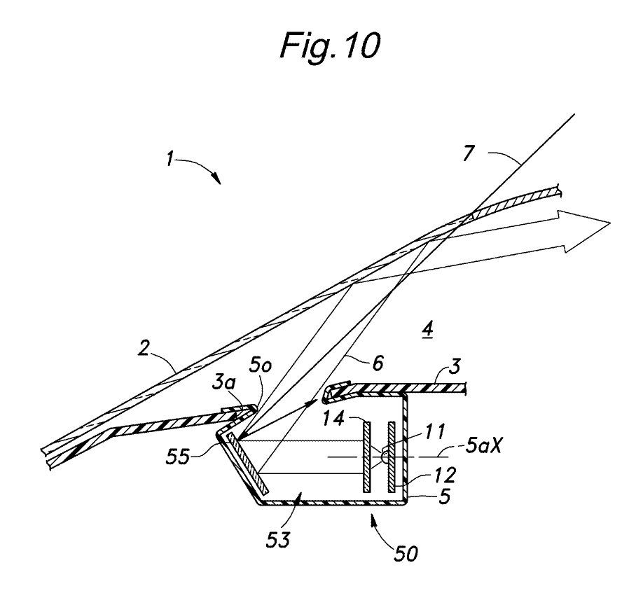

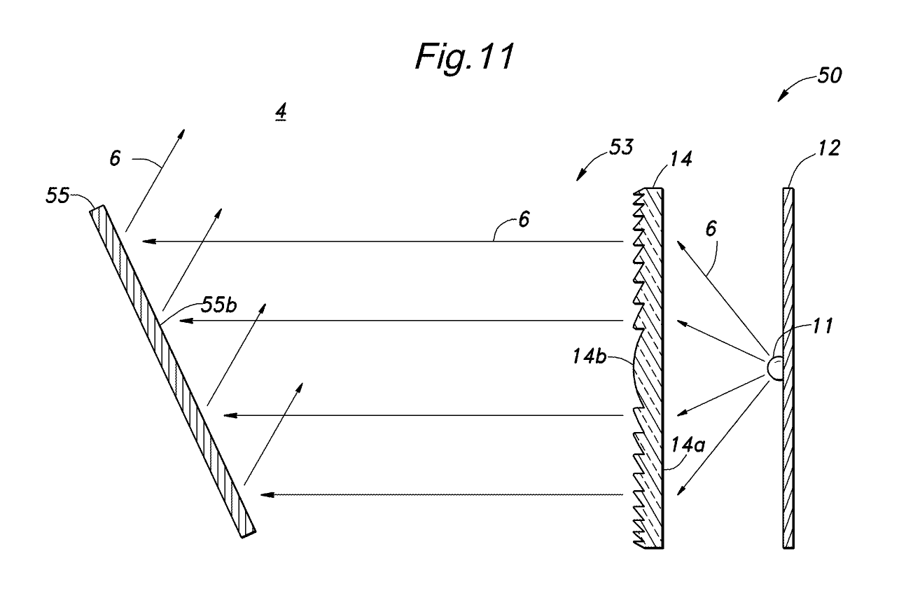

A third embodiment of the present invention is described in the following with reference to FIGS. 10 to 12. In the following description, the parts corresponding to those of the first embodiment are denoted with like numerals without repeating the description of such parts. The cylindrical housing 5 is fitted into an opening 3a of the dashboard panel 3, and has a central axial line 5ax extending in the horizontal, fore and aft direction. The head up display device 50 is installed within the housing 5.

The head up display device 50 is received in the cylindrical housing 5 with an optical axis coincident or in parallel with the central axial line 5ax of the cylindrical housing 5. The head up display device 50 comprises a light emitting display device 12 including a LED 11, and an optical unit 53 including a convex lens 14 for converting the light emitted or radiated from the light emitting display device 12 into a parallel light beam, and a mirror 55 provided in a front end of the cylindrical housing 5 and having a reflecting surface tilted forward from a vertical plane so that the parallel light beam is projected onto a prescribed area of the windshield 2 via the opening 3a in the dashboard panel 3. The convex lens 14 may be similar to that used in the first embodiment.

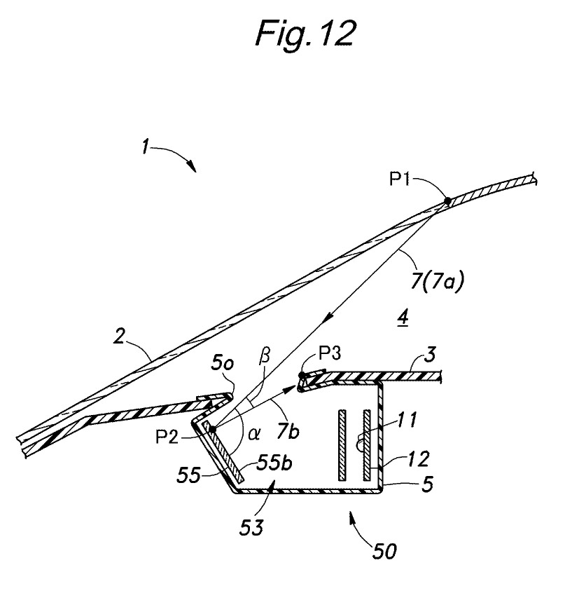

In this embodiment, as shown in FIG. 12, the angle of the mirror 55 is selected such that the reflecting surface 55b of the mirror 55 reflects the external light entering into the passenger compartment 4 via the windshield 2 onto the inner wall of the housing 5. It is again supposed that the external light 7 passes an upper edge point P1 of the windshield 2, and impinges upon the upper edge point P2 of the mirror 55. The angle between the incident light 7a and the outer surface of the mirror 55 is named as α, and the angle between the incident light 7a and the line connecting point P2 and the rear edge point of the opening 3a of the dashboard panel 3 is named as β.

If the angle α is greater than (90+β/2) degrees (α>90+β/2), the reflected light 7b impinges upon the inner wall of the housing 5, and is directed neither to the windshield 2 or into the passenger compartment 4.

By placing the housing 5 with respect to the windshield such that α is greater than (90+β/2) degrees, even when the external light 7 is passed from the uppermost point of the windshield or point P1 to the uppermost or front most point of the mirror 55, the external light 7 reflected by the mirror 55 impinges upon the inner wall of the housing 5 without being directed to the vehicle operator or to the windshield 2. Therefore, the vehicle operator is not annoyed by glare caused by the external light 7 reflected by the mirror 55 and windshield 2.

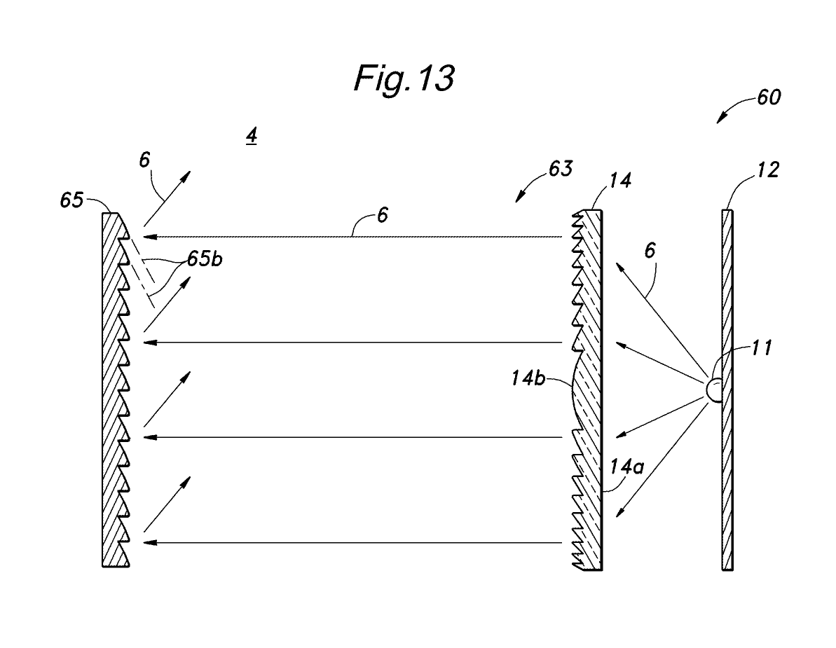

A first modification of the third embodiment is described in the following with reference to FIG. 13. In this embodiment, the optical unit 63 comprises a mirror 65 that is placed in an upright posture. This mirror 63 comprises a plurality of laterally elongated mirror sections arranged in the vertical direction on the side of the mirror 65 facing the passenger compartment 4. Each mirror segment is provided with a slanted reflective surface that reflects a horizontal light beam exiting the convex lens 14 into an upwardly slanted orientation, and impinges the reflected light beam onto the inner surface of the windshield 2. Each reflective surface 65b may be formed by depositing a layer of high reflectance metal such as silver and aluminum on the surface of the mirror 65 by vapor deposition or the like. Each reflective surface is oriented such that the aforementioned condition (or α>90+β/2) is met. In this embodiment, the mirror 65 is disposed in an upright orientation, and this enables a highly compact design of the head up display device 60.

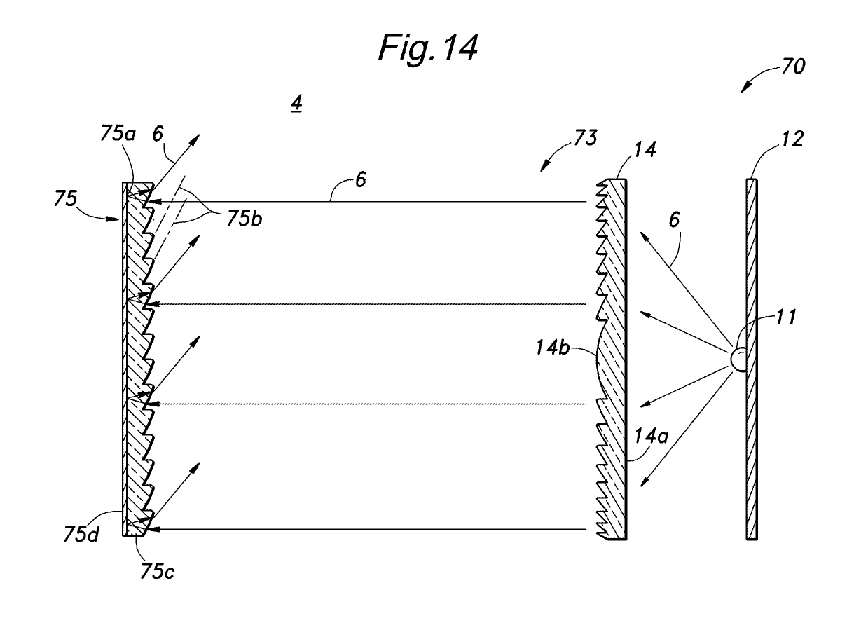

A second modification of the third embodiment is described in the following with reference to FIG. 14. In this embodiment, the optical unit 73 comprises a mirror 65 that is placed in an upright posture as in the previous modified embodiment. This mirror 75 comprises a transparent sheet 75c consisting of a plurality of laterally elongated prism sections arranged in the vertical direction, and a planar reflective layer 75d formed on the side of the transparent sheet 75c facing away from the passenger compartment 4. The reflective layer 75d may be formed by depositing a layer of high reflectance metal such as silver and aluminum on the surface of the transparent sheet 75c by vapor deposition or the like.

The side of the mirror 75 facing the passenger compartment 4 is formed with a plurality of laterally elongated slanted surfaces 75b so that the display light 6 that is impinged upon the mirror 75 is upwardly refracted by each prism section, reflected by the reflective surface 75a of the reflective layer 75d, and again upwardly refracted by the prism section before the incident light leaves the mirror 75.

Thus, the mirror 75 is in effect combined with a prism in such a fashion that the light reflected by the mirror 75 is directed upward even when the slanting angle of the mirror 75 with respect to a vertical plane may be small or even zero. Therefore, according to this embodiment, the aforementioned condition (or α>90+β/2) can be met even when the mirror 75 is disposed in an upright orientation, and this enables a highly compact design of the head up display device 70.

In the third embodiment and the two modified embodiments thereof, the reflective surfaces of the mirrors may be processed as low reflectance surfaces so that the intensity of the reflection of the external light by these mirrors may be reduced. Also, a tinted film may be used in an appropriate part of the optical unit in any of the embodiments to make use of the benefits of such a tinted film which were discussed earlier in this disclosure.

Although the present invention has been described in terms of a preferred embodiment thereof, it is obvious to a person skilled in the art that various alterations and modifications are possible without departing from the scope of the present invention which is set forth in the appended claims.

The contents of the original Japanese patent application on which the Paris Convention priority claim is made for the present application as well as the contents of the prior art references mentioned in this application are incorporated in this application by reference.

1. A head up display system for a vehicle including a windshield and a dashboard panel located opposite to an inner surface of the windshield, comprising:
a housing installed within a dashboard panel of the vehicle, and having an open end opening out in an upper wall of the dashboard panel;
a light emitting display device placed in an opposite end of the housing remote from the open end to emit a display light; and
an optical unit interposed between the light emitting display device and the open end of the housing;
wherein an outer element of the optical unit is configured to reflect an incident external light entering from the windshield at least partly at an angle to the display light emitted from the outer element of the optical unit.

2. The head up display system according to claim 1, wherein the outer element of the optical unit reflects an incident external light entering from an upper edge of the windshield onto a rear wall of the housing.

3. The head up display system according to claim 1, wherein the optical unit comprises a prism that refracts the display light emitted from the light emitting display device.

4. The head up display system according to claim 3, wherein the optical unit further comprises a convex lens interposed between the light emitting display device and the prism.

5. The head up display system according to claim 4, wherein at least one of the prism and convex lens is formed as a Fresnel lens.

6. The head up display system according to claim 5, wherein the prism and convex lens are incorporated in a single composite Fresnel lens.

7. The head up display system according to claim 1, wherein the outer element of the optical unit comprises a beam splitter.

8. The head up display system according to claim 1, wherein the optical unit further comprises a light absorbing member that attenuate light transmitted through the optical unit.

9. The head up display system according to claim 1, wherein the light emitting display device is placed in a rear end part of the housing, and the optical unit comprises a mirror provided in a front end part of the housing such that a display light emitted from the light emitting display device is reflected by the mirror, and projected onto an inner surface of the windshield via the opening in the dashboard panel.

10. The head up display system according to claim 9, wherein the mirror is incorporated with a prism layer.

11. The head up display system according to claim 9, wherein the mirror is provided with a plurality of laterally elongated reflection surface segments arranged in a vertical direction and each slanted in an upward direction.
